(19) United States
(12) Patent Application Publication
(10) Pub. No.: US 2023/0358088 A1
(43) Pub. Date: Nov. 9, 2023

(54) APPRATUS AND METHOD FOR WINDOW REGULATOR RAIL ADJUSTMENT

(71) Applicant: INTEVA PRODUCTS, LLC, Troy, MI (US)

(72) Inventors: Santosh RAMESH, Karnataka (IN); Karl-Heinz KREHER, Mühlheim (DE); Raju SIDDAPPA, Karnataka (IN)

(21) Appl. No.: 18/142,769

(22) Filed: May 3, 2023

(30) Foreign Application Priority Data
May 5, 2022 (IN) 202211026107

(51) Int. Cl. E05D 15/16

(52) U.S. Cl. CPC E05D 15/165; E05Y 2201/684; E05Y 2600/12; E05Y 2600/20; E05Y 2600/32; E05Y 2600/46; E05Y 2900/531; E05Y 2900/55

(57) ABSTRACT

An apparatus (14) for adjusting a location of a rail of a window regulator (12) with respect to a vehicle door panel (10), the apparatus including: a jack-screw (24) secured to a gear (26), the gear (26) and the jack-screw (24) being rotatably secured to the vehicle door panel (10); a worm (28) rotatably secured to the vehicle door panel (10), the worm (28) being configured to meshingly engage the gear (26); and a nut (30) secured to the rail (16), the jack-screw (24) threadingly engaging the nut (30), wherein when the worm (28) is rotated the jack-screw (24) will rotate in either a clockwise or counter clockwise direction which will cause the rail (16) to move in a direction with respect to the vehicle door panel (10).

### CROSS REFERENCE TO RELATED APPLICATIONS

This application claims priority under 35 U.S.C. § 119 to the following Indian Patent Application No. 202211026107, filed on May 5, 2022, the entire contents of which are incorporated herein by reference thereto.

### TECHNICAL FIELD

Exemplary embodiments of the present disclosure pertain to the art of vehicle windows and in particular window systems.

### BACKGROUND

Window systems are adjusted for glass sealing by adjusting the regulator rails by means of slotted brackets or Jack screws.

However, this method can limit the stiffness of the system, is costly in tools and components, and can adversely affect the glass system deflection. In addition and when the adjustment is performed on the rail, additional clearances are needed in the door for rail packaging.

### BRIEF DESCRIPTION

Disclosed is an apparatus for adjusting a location of a rail of a window regulator with respect to a vehicle door panel, the apparatus including: a jack-screw secured to a gear, the gear and the jack-screw being rotatably secured to the vehicle door panel; a worm rotatably secured to the vehicle door panel, the worm being configured to meshingly engage the gear; and a nut secured to the rail, the jack-screw threadingly engaging the nut, wherein when the worm is rotated the jack-screw will rotate in either a clockwise or counter clockwise direction which will cause the rail to move in a direction with respect to the vehicle door panel.

In addition to one or more of the features described above, the worm is accessible from outside of a vehicle door.

In addition to one or more of the features described above, the apparatus is located in a lower area of the rail.

In addition to one or more of the features described above, the vehicle door panel provides a guiding for a tool that is configured to engage a head of the worm in order to provide a rotational force to the worm.

In addition to one or more of the features described above, the apparatus is located in a lower area of the rail.

In addition to one or more of the features described above, the vehicle door panel provides a guiding for a tool that is configured to engage a head of the worm in order to provide a rotational force to the worm.

Also disclosed is a method for adjusting a location of a rail of a window regulator with respect to a vehicle door panel, including: rotatably securing a jack-screw and a gear to the vehicle door panel, the jack-screw being fixed to the gear; rotatably mounting a worm to the vehicle door panel, the worm being configured to meshingly engage the gear; and securing a nut to the rail, the jack-screw threadingly engaging the nut, wherein when the worm is rotated the jack-screw will rotate in either a clockwise or counter clockwise direction which will cause the rail to move in a direction with respect to the vehicle door panel.

In addition to one or more of the features described above, the worm is accessible from outside of a vehicle door.

In addition to one or more of the features described above, the gear and the worm are located in a lower area of the rail.

In addition to one or more of the features described above, the vehicle door panel provides a guiding for a tool that is configured to engage a head of the worm in order to provide a rotational force to the worm.

In addition to one or more of the features described above, the gear and the worm are located in a lower area of the rail.

In addition to one or more of the features described above, the gear and the worm are located in a lower area of the rail.

In addition to one or more of the features described above, the vehicle door panel provides a guiding for a tool that is configured to engage a head of the worm in order to provide a rotational force to the worm.

### BRIEF DESCRIPTION OF THE DRAWINGS

The following descriptions should not be considered limiting in any way. With reference to the accompanying drawings, like elements are numbered alike:

FIG. 1 illustrates a vehicle door panel with a window regulator and apparatus for adjusting a rail of the window regulator with respect to the vehicle door panel;

FIG. 2 is a perspective view a portion of a rail and the apparatus for adjusting a position of the rail with respect to the vehicle door panel;

FIG. 3 is a perspective view a portion of a rail and the apparatus for adjusting a position of the rail with respect to the vehicle door panel;

FIG. 4 is a perspective view a portion of a rail and the apparatus for adjusting a position of the rail with respect to the vehicle door panel;

FIG. 5 is a cross-sectional view a portion of a rail and the apparatus for adjusting a position of the rail with respect to the vehicle door panel; and

FIG. 6 is a perspective view of the apparatus for adjusting a position of the rail with respect to the vehicle door panel.

### DETAILED DESCRIPTION

A detailed description of one or more embodiments of the disclosed apparatus and method are presented herein by way of exemplification and not limitation with reference to the Figures.

The present disclosure is directed to an apparatus for adjusting the position of a rail of a window regulator with respect to a vehicle door panel.

In one embodiment, the window regulator is contemplated for use in a frameless door assembly for an automotive vehicle wherein the window has no frame surrounding its top and upper side portions of its sides when the window is in the closed position. As such, a window regulator for a frameless door assembly must provide window stability in all directions and effectuate movement of the window to and from its associated exterior seal on the vehicle as the window approaches and leaves its closed position.

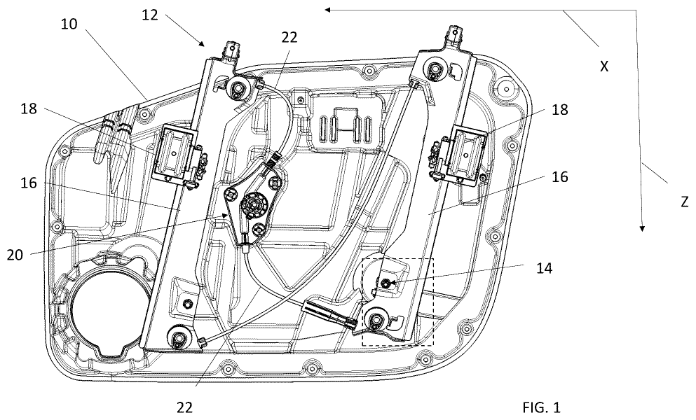

FIG. 1 illustrates a vehicle door panel or carrier plate 10 with a window regulator 12 and apparatus 14 for adjusting a rail 16 of the window regulator 12 with respect to the vehicle door panel 10. As is known in the related arts, a window regulator 12 has a rail or rails 16 each slidably receiving a cursor 18. The cursor 18 is secured to a window of the vehicle door. The window regulator 12 also includes a motor assembly 20 that drives the cursors 10 up and down on the rails 16 by winding and unwinding cables 22 secured to the motor assembly 20 at one end and the cursors 18 at an opposite end.

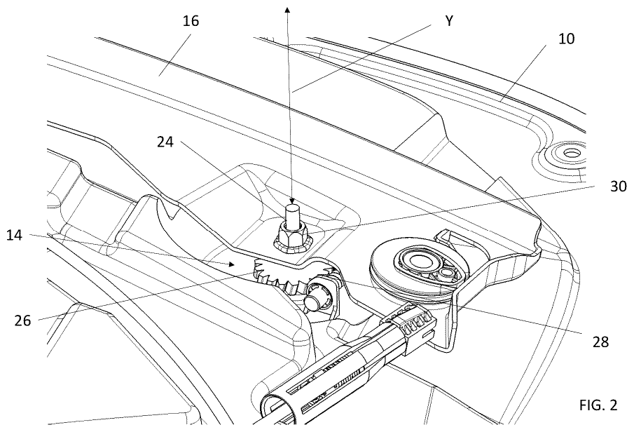

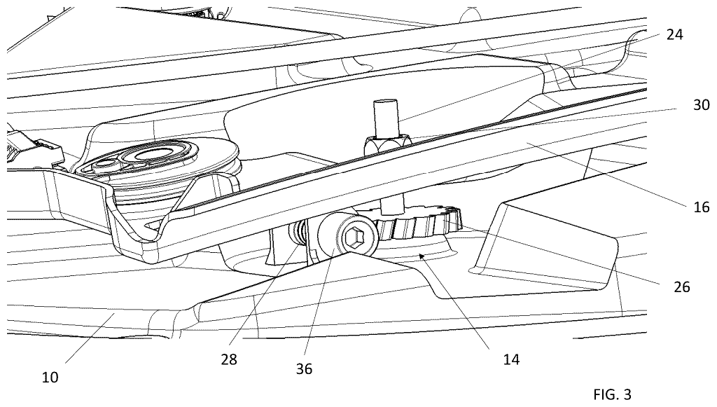

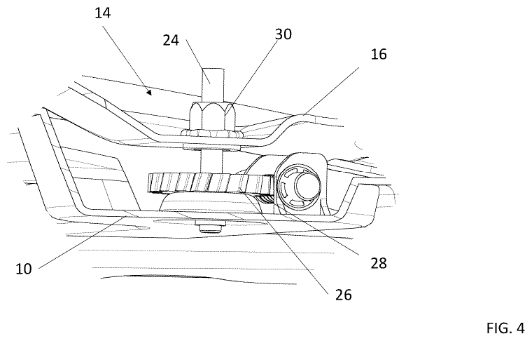

FIGS. 2-4 are various perspective views a portion of a rail 16 and the vehicle door panel 10 as well as the apparatus 14 for adjusting a position of the rail 16 with respect to the vehicle door panel 10. The apparatus 14 includes a jack-screw 24 that is fixedly secured to a gear 26 such that the gear 26 and the jack-screw 24 rotate together. The gear 26 and the jack-screw 24 are rotatably secured to the vehicle door panel 10. The apparatus 14 also includes a worm 28 that is rotatably secured to the vehicle door panel 10. The worm 28 is configured to meshingly engage the gear 26. As such and when the worm 28 is rotated gear 26 and jack-screw 24 are rotated. The jack-screw 24 is configured to threadingly engage a nut 30 secured to the rail 16. As such and when the worm 28 is rotated the jack-screw 24 will rotate in either a clockwise or counter clockwise direction which will cause the rail to move in the Y direction with respect to the vehicle door panel 10.

The apparatus 14 and gear set up will allow for tuning of the rail 16 in the Y directed from outside of the vehicle door by rotating the worm in any direction between the Z and X directions illustrated in FIG. 1. For example, a tool for rotating the worm can be inserted into the door from any direction between the Z and X directions depending upon the orientation of the worm 28 on the vehicle door panel 10.

The gear drive setup is self-locking due to worm/gear connection. The worm 28 can be driven by a Hexagon, Torx or Imbus tool with an appropriate length which turns the worm 28 which drives the gear 26. As mentioned above, the gear 26 will turn the jack-screw 24 which then moves the nut 30 in the Y-direction which is fixed to the rail 16. As such, rotation of the worm 28 causes adjustment of the rail 16 in the Y direction.

As illustrated, the apparatus 14 is located in a lower area (illustrated by the dashed lines in FIG. 1) of the rail 16 (e.g., an area that is further from an upper portion or sill of the vehicle door).

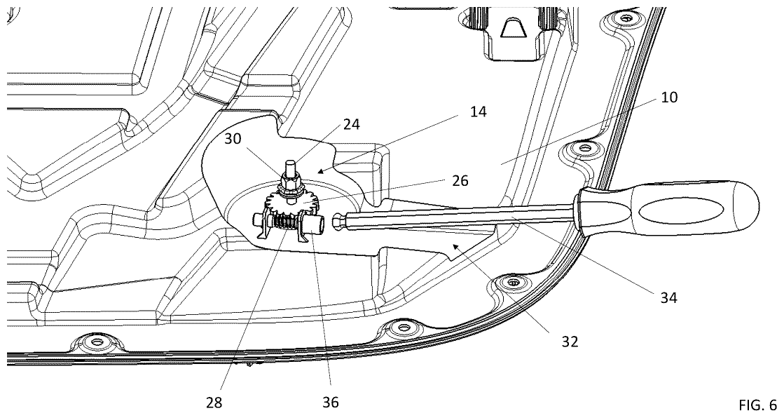

In one non-limiting embodiment, the vehicle door panel 10 can provide guiding 32 for a tool 34 (illustrated by the dashed lines in FIG. 6) that is configured to engage a head 36 of the worm 28 in order to provide a rotational force to the worm 28.

In one non-limiting embodiment, the vehicle door will have a hole aligned with the worm such that an individual will be able to do fine tune the location of the rail 16 by just removing a cover on the hole in the vehicle door without the need to disassemble the vehicle door trim.

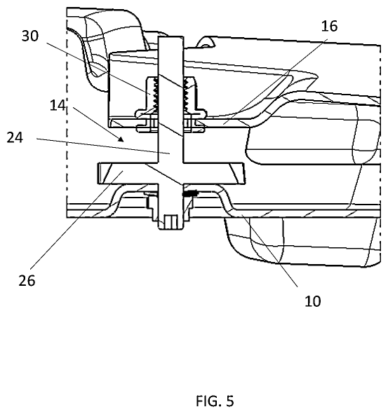

FIG. 5 is a cross-sectional view the apparatus 14.

FIG. 6 is a perspective view of the apparatus 14 on the vehicle door panel 10 with the rail 16 removed for clarity purposes.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An apparatus (14) for adjusting a location of a rail of a window regulator (12) with respect to a vehicle door panel (10), the apparatus comprising:
a jack-screw (24) secured to a gear (26), the gear (26) and the jack-screw (24) being rotatably secured to the vehicle door panel (10);
a worm (28) rotatably secured to the vehicle door panel (10), the worm (28) being configured to meshingly engage the gear (26); and
a nut (30) secured to the rail (16), the jack-screw (24) threadingly engaging the nut (30), wherein when the worm (28) is rotated the jack-screw (24) will rotate in either a clockwise or counter clockwise direction which will cause the rail (16) to move in a direction with respect to the vehicle door panel (10).

2. The apparatus as in claim 1, wherein worm (28) is accessible from outside of a vehicle door.

3. The apparatus as in claim 1, wherein the apparatus is located in a lower area of the rail.

4. The apparatus as in claim 1, wherein the vehicle door panel (10) provides a guiding (32) for a tool (34) that is configured to engage a head (36) of the worm (28) in order to provide a rotational force to the worm (28).

5. The apparatus as in claim 4, wherein the apparatus is located in a lower area of the rail.

6. The apparatus as in claim 2, wherein the apparatus is located in a lower area of the rail.

7. The apparatus as in claim 6, wherein the vehicle door panel (10) provides a guiding (32) for a tool (34) that is configured to engage a head (36) of the worm (28) in order to provide a rotational force to the worm (28).

8. A method for adjusting a location of a rail (16) of a window regulator (12) with respect to a vehicle door panel (10), comprising:
rotatably securing a jack-screw (24) and a gear (26) to the vehicle door panel (10), the jack-screw being fixed to the gear (26);
rotatably mounting a worm (28) to the vehicle door panel (10), the worm (28) being configured to meshingly engage the gear (26); and
securing a nut (30) to the rail (16), the jack-screw (24) threadingly engaging the nut (30), wherein when the worm (28) is rotated the jack-screw (24) will rotate in either a clockwise or counter clockwise direction which will cause the rail (16) to move in a direction with respect to the vehicle door panel (10).

9. The method as in claim 8, wherein worm (28) is accessible from outside of a vehicle door.

10. The method as in claim 8, wherein the gear (26) and the worm (28) are located in a lower area of the rail.

11. The method as in claim 8, wherein the vehicle door panel (10) provides a guiding (32) for a tool (34) that is configured to engage a head (36) of the worm (28) in order to provide a rotational force to the worm (28).

12. The method as in claim 11, wherein the gear (26) and the worm (28) are located in a lower area of the rail.

13. The method as in claim 9, wherein the gear (26) and the worm (28) are located in a lower area of the rail.

14. The method as in claim 13, wherein the vehicle door panel (10) provides a guiding (32) for a tool (34) that is configured to engage a head (36) of the worm (28) in order to provide a rotational force to the worm (28).
